(19) United States
(12) Patent Application Publication
(10) Pub. No.: US 2024/0295361 A1
(43) Pub. Date: Sep. 5, 2024

(54) Dryer And Drying Unit For Drying Paper Tubes

(71) Applicant: International Tobacco Machinery Poland SP. Z O.O., Radom (PL)

(72) Inventors: Radoslaw OWCZAREK, Radom (PL); Tadeusz KOWALCZYK, Radom (PL)

(21) Appl. No.: 18/547,761

(22) PCT Filed: Mar. 2, 2022
(86) PCT No.: PCT/IB2022/051823

§ 371 Date: Aug. 24, 2023

(30) Foreign Application Priority Data
Mar. 5, 2021 (PL) PL437207

(51) Int. Cl. F26B 15/22; F26B 3/04; F26B 17/02

(52) U.S. Cl. CPC F26B 15/22; F26B 3/04; F26B 17/026

(57) ABSTRACT

A dryer (2) for drying paper tubes (4) conveyed in a multilayer stream (W) transversely to the axis of the paper tubes (4), comprising an inlet (6) adapted to passing through it of a conveyor (3) of the multilayer stream (W), an outlet (7) adapted to passing through it of the conveyor (3) of the multilayer stream (W), at least one drying chamber (5) situated between the inlet (6) and the outlet (7), adapted to receive the conveyor (3) of the multilayer stream (W), at least one heater (8) to heat the air, at least one fan (9) to blow the heated air into the drying chamber (5). At least one wall (13, 14) of the dryer (2) is provided with at least one blowing element (15) for the heated air, and the blowing direction (R) of the heated air through the blowing element (15) is situated substantially transversely to the longitudinal axis (k) of the drying chamber (5) of the dryer (2).

The object of the invention is a dryer and a drying unit for drying paper tubes.

The invention relates to the manufacture of paper products for the food industry, in particular in the manufacture of drinking accessories such as paper drinking straws.

The publication GB 1 088 745 discloses a rotary tube dryer wherein the tubes circulate around the circumference of the wheels and are individually fed into and carried away from the dryer.

The publication GB 291 102 discloses a dryer wherein the cardboard tubes are dried individually and each tube is rotated individually during the drying process.

The publication WO 2017/080067A1 discloses a dryer having three drying sections wherein in the first section the drying is performed using hot air, in the second section the drying is performed using microwave radiation, and in the third section the drying is performed using cool air.

There are known drying units in which heating elements such as an irradiator are used, whereas in these solutions there is one-sided heating of the dried products, which leads to their deformation. Drying units of such type require the use of a single layer arrangement of dried products situated on a horizontal supporting surface. There are known drying units in which the heated air stream is directed from above onto the articles moving horizontally along the conveyor.

The object of the invention is a dryer for drying paper tubes conveyed in a multilayer stream transversely to the axis of the paper tubes, comprising an inlet adapted to passing through it of a conveyor of the multilayer stream, an outlet adapted to passing through it of the conveyor of the multilayer stream, at least one drying chamber situated between the inlet and the outlet, adapted to receive conveyor of the multilayer stream, at least one heater to heat the air, at least one fan to blow the heated air into the drying chamber. At least one wall of the dryer is provided with at least one blowing element for the heated air, and the direction of blowing the heated air through the blowing element is situated substantially transversely to the longitudinal axis of the drying chamber of the dryer.

The dryer according to the invention is characterised in that the conveyor of the multilayer stream is adapted to hold the multilayer stream bilaterally by means of supporting surfaces.

The dryer according to the invention is characterised in that the blowing element for the heated air is adapted to blow the heated air in a blowing direction substantially parallel to the supporting surfaces of the conveyor of the multilayer stream.

The dryer according to the invention is characterised in that at least one of the two opposite walls of the drying chamber is provided with the blowing elements for blowing the heated air.

The dryer according to the invention is characterised by being provided with at least two drying zones at least partially separated from each other, the drying zone being provided with a fan.

The dryer according to the invention is characterised in that in successive drying zones the blowing elements are arranged respectively on different sides of the drying chamber.

The dryer according to the invention is characterised in that the heating chambers of the drying zones are separated from each other by walls.

The dryer according to the invention is characterised in that in the drying zone the air circulation passes through the drying chamber, the openings in the front wall, the channel, the fan, the heating chamber and the blowing elements in the side wall.

The dryer according to the invention is characterised in that the drying chamber is vertically positioned.

The dryer according to the invention is characterised in that the inlet and the outlet are adapted to a conveyor provided with two supporting elements.

The object of the invention is also a drying unit for drying the paper tubes conveyed in the multilayer stream, comprising the dryer according to the invention and the conveyor of the multilayer stream. The conveyor of the multilayer stream is provided with two supporting surfaces adapted to hold the multilayer stream bilaterally, the direction of blowing of the heated air through the blowing element is transverse to the conveying direction of the multilayer stream of the paper tubes.

The drying unit according to the invention is characterised in that the blowing element for the heated air is adapted to blow the heated air in the blowing direction substantially parallel to the supporting surfaces of the conveyor of the multilayer stream.

The drying unit according to the invention is characterised in that the blowing direction of the heated air is in line with the axes of the paper tubes conveyed in the multilayer stream.

The drying unit according to the invention is characterised in that the supporting surfaces are formed on a chain conveyor.

The drying unit according to the invention is characterised in that the supporting surfaces are provided with humps situated transversely to the conveying direction of the conveyor.

The dryer according to the invention effectively reduces the moisture content of the conveyed paper tubes while maintaining their shape. Drying the tubes conveyed as a mass flow held by two supporting surfaces allows to avoid bending of the tubes which support one another or find support in the supporting surfaces of the conveyor. Furthermore, the stream of tubes can be directed at any angle during drying so the entire drying unit can be positioned at any angle.

The object of the invention was shown in more detail in a preferred embodiment in a drawing in which:

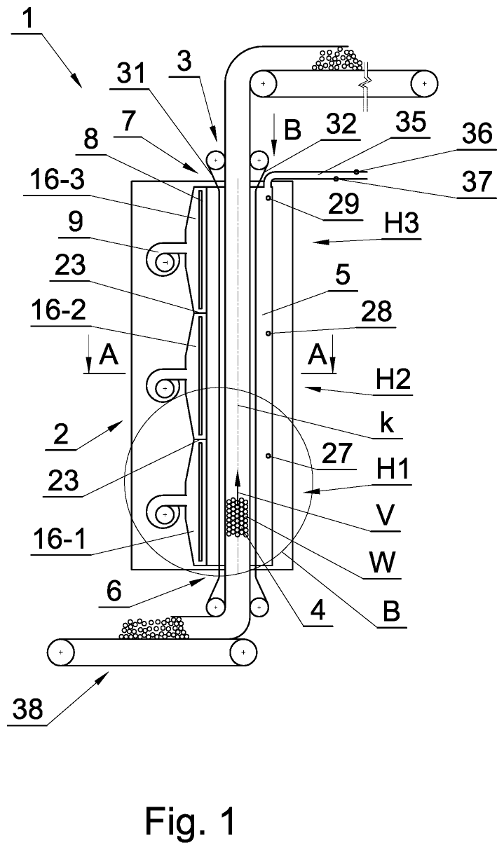

FIG. 1 shows a drying unit in vertical configuration,

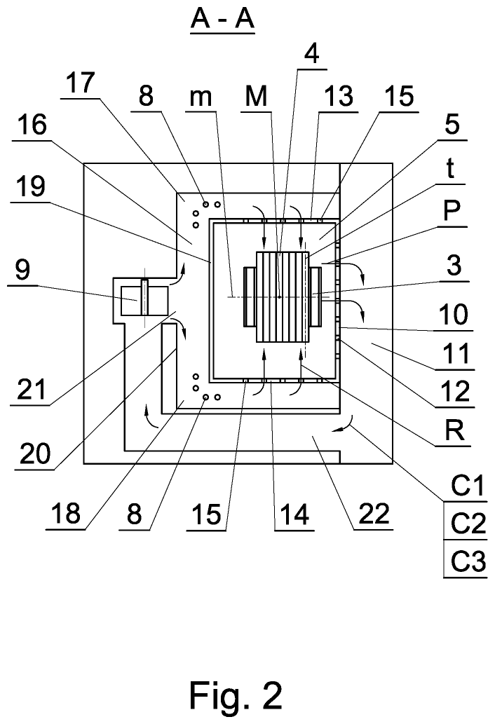

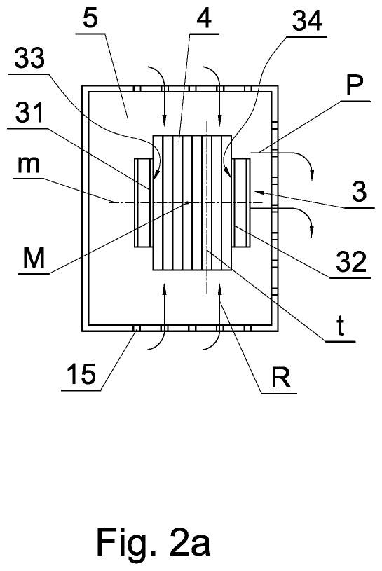

FIG. 2 shows a cross-section through the drying unit,

FIG. 2a shows a fragment of the cross-section of FIG. 2,

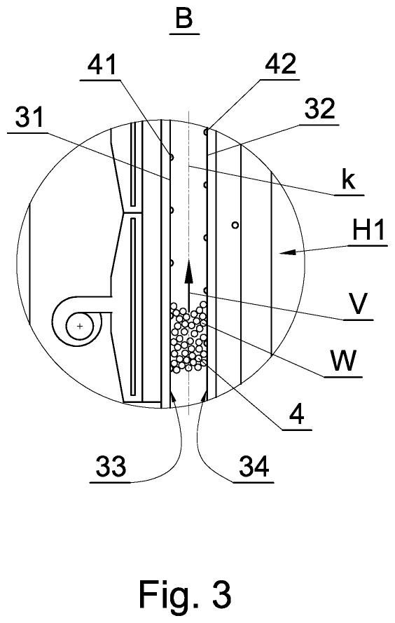

FIG. 3 shows a view of an outlet of the drying unit, and

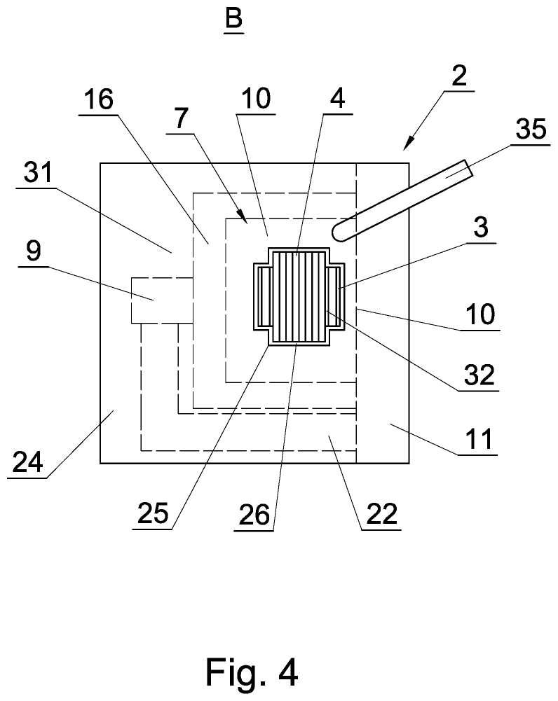

FIG. 4 shows the drying unit in horizontal configuration.

A drying unit 1 shown in FIG. 1 is adapted to dry paper tubes 4 during the conveyance of such tubes in a multilayer stream W. The drying unit 1 comprises a dryer 2 and a conveyor 3 adapted to convey the multilayer stream W of paper tubes 4. The paper tubes 4 in the stream W may be arranged in a regular manner (in a view as in FIG. 1 an arrangement similar to a honeycomb) as well as in an irregular manner. The dryer 2 shown in FIG. 1 comprises a drying chamber 5, an inlet 6, an outlet 7, heaters 8 and a fan 9. The conveyor 3 adapted to convey the multilayer stream W of tubes 4 passes through the inlet 6 and through the outlet 7. The inlet 6 and the outlet 7 may be provided with seals to prevent an uncontrolled outflow of heated air and an intake of cool air from the environment, the seals being adapted to the supporting elements of the conveyor 3 and the width of the stream W. The conveyor 3, and thus the conveying direction V of the stream W, may be at any angle to the horizontal plane, in the embodiment shown in FIG. 1 the conveyor 3 is positioned vertically, the drying chamber 5 is embodied as longitudinal and is also positioned vertically, the conveyor 3 running in line with the longitudinal axis k of the drying chamber 5 from the inlet 6 to the outlet 7. In FIG. 2, a cross-section A-A through the drying unit 1 is shown. The front wall 10 of the drying chamber 5 situated between the drying chamber 5 and the front chamber 11 is partly embodied as openwork, the openings 12 made in the front wall 10 allow an air flow from the drying chamber 5 to the front chamber 11. The front wall 10 may be partly in the form of a grid. It is possible to make a single opening 12 in the front wall 10 providing the air flow. The side walls 13 and 14 are provided with blowing elements 15, whereas the blowing may be provided so that the side walls 13, 14 are partly embodied as openwork, for example they may be in the form of a grid. The blowing elements may be in the form of blowing openings 15 allowing heated air to flow from the heating chamber 16 to the drying chamber 5. It is possible to make a single blowing opening 15 providing the air flow. The blowing elements 15 ensure feeding, i.e. blowing of the heated air in the blowing direction R, being transverse to the conveying direction V of the tubes 4 in the multilayer stream W (the direction V is the conveying direction of the conveyor 3).

FIG. 2a shows an enlarged fragment of the sectional view of FIG. 2, comprising only a cross-section through the drying chamber 5 and the conveyor 3. The conveyor 3 of the multilayer stream W is provided with two supporting elements 31 and 32, for example belts or chains, for conveying the dried tubes 4. The supporting element 31 is provided with a supporting surface 33, and the supporting element 32 is provided with a supporting surface 34. The supporting surface 33 and the supporting surface 34 are arranged parallel to each other. Between the supporting surfaces 33, 34 there are the conveyed tubes 4 of the multilayer stream W. The drying chamber 5 is sufficiently wide to accommodate the supporting elements 31, 32. The supporting elements 31, 32 may be in the form of belts or chains. The supporting surfaces 33, 34 may be provided with humps 41, 42 (FIG. 3) positioned transversely to the conveying direction V of the conveyor 3, the humps 41, 42 may have a length equal to the width of the supporting surfaces 31, 32 or shorter. The blowing openings 15 allow the heated air to be fed in a blowing direction R being transverse to the conveying direction V of the multilayer stream W, and in the shown embodiment in the blowing direction R parallel to the supporting surfaces 33 and 34 and at the same time parallel to the axis t of the tubes 4. Such positioning of the blowing direction R of the heated air enables the hot air to penetrate inside the tubes and allows efficient drying. During drying, the tubes 4 are held either only by the adjacent tubes 4 or by the adjacent tubes 4 and the supporting surface 33 or 34. The flow of the multilayer stream of tubes 4 through the dryer 2 ensures that any potential deformation of the tubes 4 associated with changes in moisture content, which may be at least partially non-uniform, is eliminated.

In the cross-section shown in FIG. 2, the heating chamber 16 is C-shaped, the heating chamber 16 surrounds the drying chamber 5, with the heaters 8 being situated at the corners 17, 18 of the heating chamber 16. The rear wall 19 of the drying chamber 5, which separates the drying chamber 5 from the heating chamber 16, is a solid wall, i.e. without any openings. In the outer rear wall 20 of the heating chamber 16, there is an opening 21 through which the air is supplied to the heating chamber 16 by a fan 9. The fan 9 draws air through a channel 22 from the front chamber 11 which is flow connected to the drying chamber 5 through openings 12 made in the front wall 10 of the drying chamber 5. The air may be supplied from outside the drying unit directly to the drying chamber 5 or to the fan 9.

The dryer 2 may be provided with an inlet channel for the air in the lower part of the dryer (not shown) and an air outlet channel 35 in the upper part of the dryer, and the lower surface of the drying chamber 5 may be in the form of openwork. The dryer 2 may be provided with a single fan 9 forcing the movement of air around the heaters 8 and further into the drying chamber 5. Preferably, the dryer 2 may be provided with at least two fans 9 and the dryer 2 may be divided into at least two drying zones, whereas the division of the dryer 2 into drying zones may be applied either in a vertical configuration, a horizontal configuration or any other configuration. In the case of a vertical configuration, the air for the drying zone situated above may be drawn from the lower drying zone. The dryer 2 in the shown embodiment is provided with three fans 9 situated in three drying zones H1, H2 and H3. The drying zones H1, H2, H3 have partially separate air circulations, the drying zones H1, H2, H3 being separated by walls 23. The fan 9 in each zone is flow connected to the front chamber 11 by means of a channel 22. Furthermore, in the successive drying zones H1, H2 or H3, the blowing elements 15 may be arranged respectively on different sides of the drying chamber 5 so as to change the direction of the air flow in the successive drying zones H1, H2 or H3, which has an effect on the drying efficiency. Moreover, the sequence of alternate directions of air flow in the drying zones is only an example as the directions of air flow are selected depending on technological requirements of the process of drying a given type of product.

In particular drying zones H1, H2, H3 it is possible to regulate the drying temperature independently, depending on the technological requirements of the drying process. Preferably, the drying temperature is about 100° C. The dryer is provided with temperature sensors, the drying zone H1 is provided with a temperature sensor 27, the drying zone H2 with a sensor 28 and the drying zone H3 with a sensor 29. An air temperature sensor 36 and an air humidity sensor 37 are situated in the air outlet channel 35 above the drying zone H3. The dryer according to the invention, due to the fact that it is provided with both air temperature sensors and air humidity sensors, may receive information about these parameters from external sources, is characterised by technological flexibility and may be used for drying paper tubes with different humidity parameters as well as with different drying susceptibility.

During the operation of the drying unit 1 (FIG. 2), the air, forced by the fan 9, flows into the heating chamber 16, is heated by the heaters 8, and the heated air flows into the drying chamber 5 through the blowing openings 15 in the side walls 13 and 14. The heated air flows around the multilayer stream W of the tubes 4, partially flows into the tubes 4, and then the air flows through the openings 12 in the front wall 10 into the front chamber 11, from the front chamber 11 the air is drawn by the fan 9 through the channel 22. The drying takes place due to the flow connection of the drying chamber 5, the front chamber 11, the channel 22 and the fan 9, a partially closed air circulation is formed. In the cross-section A-A, the air circulation C2 in the drying zone H2 is shown with arrows, whereas the air circulation C1 in the drying zone H1 and the air circulation C3 in the drying zone H3 are similarly shaped. The air circulation C1, C2, C3 in the heating zone H1, H2, H3 is partially separated from the adjacent circulation by the walls 23 between the adjacent heating chambers 16-1, 16-2, 16-3. The air circulations C1, C2, C3 of the adjacent drying zones H1, H2, H3 are connected within the drying chamber 5 and the front chamber 11. Equipping the dryer with several drying zones provides greater drying efficiency, the air temperature in each successive zone from the inlet to the outlet may be higher and higher.

For effective drying, it is essential that the direction R of blowing the air onto the tubes is in line with the axes t of the paper tubes 4, the air may then easily flow into the tubes. The air blowing direction R may be defined as substantially perpendicular to the plane m in which the geometric centres M of the paper tubes 4 move. In turn, the direction P of receiving the air from the drying chamber 5 is transverse or substantially perpendicular to the axis t of the paper tubes 4.

It is possible to embody the heating chamber 16 in an L-shaped cross-section, with only one wall being provided with openings 15 through which the heated air could fall into the drying chamber 5.

In FIG. 4, the outlet 7 of the dryer 2 is shown, whereas in the upper wall 24 of the dryer 2 there is provided an outlet opening 25 through which the conveyor 3 passes. The outlet opening 25 (similarly, an inlet opening on the opposite wall) may be provided with a seal 26 to ensure that the gap at the conveyor 3 and the tubes 4 is kept as small as possible. The shape of the outlet opening 25 is adapted to the shape of the supporting elements 31, 32 and to the cross-section of the stream W. The chambers and the channels of the dryer are shown by dashed lines.

The tubes may be fed to the drying unit 1 by a conveyor 38 and received by a conveyor 39, these may be conveyors adapted to a multilayer stream of tubes.

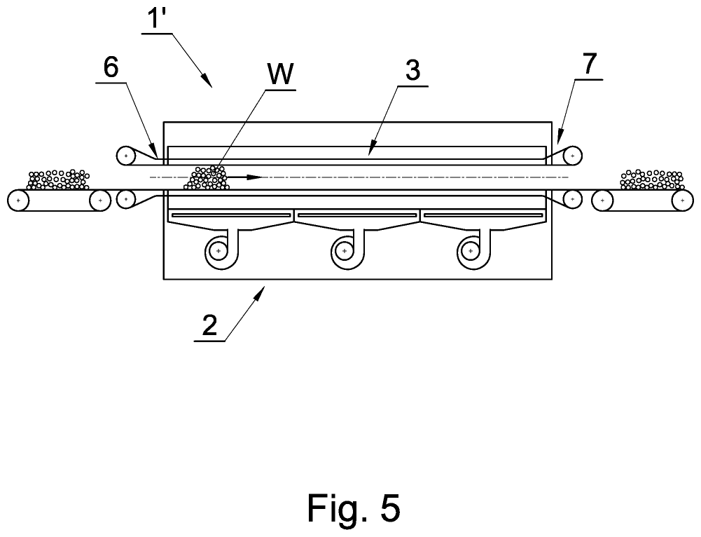

The drying unit 1′ in the second embodiment shown in FIG. 5 is built in a horizontal configuration. The conveyor 3 conveys the tubes 4 in the multilayer stream W from the inlet 6 to the outlet 7. The dryer 2 is built as in the first embodiment.

1. A dryer (2) for drying paper tubes (4) conveyed in a multilayer stream (W) transversely to the axis of the paper tubes (4) comprising
an inlet (6) adapted to receiving a conveyor (3) of the multilayer stream (W) so that the conveyor passes through the inlet (6),
an outlet (7) adapted to receiving the conveyor (3) of the multilayer stream (W) so that the conveyor passes through the outlet (7),
at least one drying chamber (5) situated between the inlet (6) and the outlet (7), adapted to receive the conveyor (3) of the multilayer stream (W),
at least one heater (8) to heat the air,
at least one fan (9) to blow the heated air into the drying chamber (5),
wherein at least one wall (13, 14) of the dryer (2) is provided with at least one blowing element (15) for the heated air, and wherein the blowing direction (R) of the heated air through the blowing element (15) is situated substantially transversely to the longitudinal axis (k) of the drying chamber (5) of the dryer (2).

2. The dryer as in claim 1, characterised in that the conveyor (3) of the multilayer stream (W) is adapted to hold the multilayer stream (W) at two sides by means of supporting surfaces (33, 34).

3. The dryer as in claim 2, characterised in that the blowing element (15) for the heated air is adapted to blow the heated air in a blowing direction (R) substantially parallel to the supporting surfaces (33, 34) of the conveyor (3) of the multilayer stream (W).

4. The dryer as in any of claims 1 to 3, characterised in that at least one of the two opposite walls (13, 14) of the drying chamber (5) is provided with the blowing elements (15) for blowing the heated air.

5. The dryer as in any of claims 1 to 4, characterised by being provided with at least two drying zones (H1, H2) at least partially separated from each other, the drying zone (H1, H2) being provided with a fan (9).

6. The dryer as in claim 5, characterised in that in successive drying zones (H1, H2) the blowing elements (15) are arranged respectively on different sides of the drying chamber (5).

7. The dryer as in claim 5 or 6, characterised in that the heating chambers (16) of the drying zones (H1, H2, H3) are separated from each other by walls (23).

8. The dryer as in any of claims 5 to 7, characterised in that in the drying zone (H1, H2, H3) the air circulation (C1, C2, C3) passes through the drying chamber (5), the openings (12) in the front wall (10), the channel (22), the fan (9), the heating chamber (16) and the blowing elements (15) in the side wall (13, 14).

9. The dryer as in any of the preceding claims, characterised in that the drying chamber (5) is positioned vertically.

10. The dryer as in any of the preceding claims, characterised in that the inlet (6) and the outlet (7) are adapted to a conveyor (3) provided with two supporting elements (31, 32).

11. A drying unit (1) for drying the paper tubes (4) conveyed in the multilayer stream (W), comprising the dryer (2) as in any of claims 1 to 10 and the conveyor (3) of the multilayer stream (W), wherein the conveyor (3) of the multilayer stream (W) is provided with two supporting surfaces (33, 34) adapted to hold the multilayer stream (W) at two sides, and wherein the blowing direction (R) of the heated air through the blowing element (15) is transverse to the conveying direction (V) of the multilayer stream (W) of the paper tubes (4).

12. The drying unit as in claim 11, characterised in that the blowing element (15) for the heated air is adapted to blow the heated air in the blowing direction (R) substantially parallel to the supporting surfaces (33, 34) of the conveyor (3) of the multilayer stream (W).

13. The drying unit as in claim 12, characterised in that the blowing direction (R) of the heated air is in line with the axes (t) of the paper tubes (4) conveyed in the multilayer stream (W).

14. The drying unit as in any of claims 11 to 13, characterised in that the supporting surfaces (33, 34) are formed on a chain conveyor.

15. The drying unit as in any of claims 11 to 14, characterised in that the supporting surfaces (33, 34) are provided with projections (41, 42) situated transversely to the conveying direction (V) of the conveyor (3).
